(19) United States
(12) Patent Application Publication
(10) Pub. No.: US 2026/0178971 A1
(43) Pub. Date: Jun. 25, 2026

(54) PHYSICS COMPLIANCE INDICATOR (PCI) FOR MACHINE LEARNING

(71) Applicant: University of Kansas, Lawrence, KS (US)

(72) Inventors: Amirmasoud Kalantari Dahaghi, Lawrence, KS (US); Vuong Van Pham, Lawrence, KS (US); Temoor Muther, Lawrence, KS (US)

(21) Appl. No.: 19/129,704

(22) PCT Filed: Nov. 16, 2023
(86) PCT No.: PCT/US2023/080166

§ 371 Date: May 14, 2025

Related U.S. Application Data
(60) Provisional application No. 63/426,641, filed on Nov. 18, 2022.

(51) Int. Cl. G06N 20/00; G06N 3/045; G06N 3/08

(52) U.S. Cl. CPC G06N 20/00; G06N 3/045; G06N 3/08

(57) ABSTRACT

Systems and methods according to the present disclosure provide functionality for supporting design and use machine learning models and for quantifying an impact of physical laws on the machine learning models. In an aspect, a set of parameters for the machine learning model are defined. The parameters include physics compliance indicator (PCI) hyperparameters associated with physics defined behaviors (PDBs). The PDBs indicate expected responses/behavior changes with respect to variation of input 2024/108057 parameter values due to the impact of physics. The machine learning model may be trained for at least one epoch, and PCI logs including PCI scores for each PCI hyperparameter may be generated based on the training. Each PCI score of the PCI logs quantifies a compliance of the machine learning model with one or more physical laws associated with the PDB of the each PCI hyperparameter during a particular epoch of the training.

### CROSS REFERENCE TO RELATED APPLICATIONS

The present application claims the benefit of priority from U.S. Provisional Ser. No. 63/426,641 , filed Nov. 18, 2022 and entitled “PHYSICS COMPLIANCE INDICATOR (PCI) FOR MACHINE LEARNING” the disclosure of which is incorporated by reference herein in its entirety.

### TECHNICAL FIELD

The present invention disclosure generally relates to machine learning model design and, more specifically, to developing an enhanced artificial neural network (E-ANN) design that significantly improves trustworthy of artificial neural network (ANN) models representing real world systems subject to the laws of physics.

### BACKGROUND

Machine learning models are being extensively applied across many industries and applications to gain insights and understanding of data through experiments and modelling. As an example, artificial neural networks (ANNs) may be used to understand the response from physical systems, designing new materials, optimizing surface and subsurface physical system functionality, improving the performance, autonomous monitoring and surveillance, autonomous tools and systems and self-supervised physical systems and drug discovery. Although significant advancement has been made in both the development and application of ANNs, ANNs may not be used with confidence for systems that function and operate according to physical laws, including multi-physicochemical laws and rules.

Some attempts have been made to address this issue by developing the so-called Physics Informed Neural Network (PINN) or Science Informed Neural Network. However, presently developed PINNs are limited to solving partial differential equations (PDEs) with neural networks one at a time and are not able to solve coupled PDEs simultaneously, such as may be used to solve for the physical response of many physics-based systems. Therefore, PINNs may not be easily applied to all physical systems and especially to input-output data sets generated from these systems. Due to such limitations, applications utilizing PINNs (in their current form) are limited, significantly increase computational time and/or computational resources, and suffer from error cascade. Additionally, applications utilizing PINNs provide limited scalability, especially for high dimensional data and heterogeneous systems, which reduces PINNs efficiency. The required components for constructing these PINNs, such as a detailed description of PDEs, initial conditions, and boundary conditions, may also not be available, resulting in further performance degradations and further reducing insights provided by the model(s).

### SUMMARY

In view of the drawbacks and limitations of artificial neural networks (ANNs) outlined above, and machine learning models generally, it would be beneficial to provide a mechanism, tool, or methodology for evaluating ANNs and other machine learning models against sensitivities to the physical components and physics constraints that are flexible and can be integrated easily and fully into any type of ANN or machine learning model. Preferably, such a solution could be applied to all described physical system modeling and would not impact the computational time, while maintaining the ability to generate physically meaningful ANN models that not only generate reliable results and honor physical laws and rules, but also enable the generated ANN models to be deployed in mission-critical conditions and recommend sensitive actions, propose designs, control the system behavior, and predict the performance with higher accuracy and with more confidence.

Consistent with the foregoing, aspects of the present disclosure are directed to systems and methods for providing a Physics Compliance Indicator (PCI) as a new building block to upgrade and enhance conventional ANNs with respect to ANN design and for providing an Enhanced-ANN (E-ANN) design framework. The disclosed systems and methods provide functionality for supporting design and use machine learning models, such as E-ANNs, and for quantifying an impact of physical laws on the machine learning models. During a design phase of an E-ANN in accordance with the present disclosure, a set of parameters may be defined. The set of parameters may be selected based on a set of data (e.g., a test and train data set for the relevant model) and may include PCI hyperparameters, which represent parameters that may be impacted by physics applicable to the modeled system. The PCI hyperparameters may be associated with physics defined behaviors (PDBs) representing or indicating expected responses/behavior changes with respect to variation of input parameter values due to the impact of physics.

Once the set of PCI hyperparameters are defined, additional model parameters may be configured, such as to associate PCI hyperparameters with a weight indicating the contribution that each PCI hyperparameter has on the overall impact that physical laws have on the modeled system. Additionally, boundary constraints may be defined to constrain the parameter values within desired ranges. Training stopping criteria may also be defined to specify how long training should be performed and when training should be stopped. During training, PCI logs may be generated that include PCI scores associated with individual PCI hyperparameters, as well as a cumulative PCI score associated with the model as a whole. The PCI scores may indicate how well the model is learning the physics applicable to the model, such as the physics response associated with the PDB of each PCI hyperparameter. The PCI logs may be output to a graphical user interface for display to a user, which may enable the user to view how well the model is learning the physics-based behaviors of the system represented by the model. In this manner, the compliance of a machine learning model, such as an E-ANN, with applicable physical laws and constraints may be quantified, thereby eliminating the uncertainty present in current machine learning modelling systems.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

For a more complete understanding of the present disclosure, reference is now made to the following descriptions taken in conjunction with the accompanying drawings, in which:

FIG. 1 is a block diagram of an exemplary system for performing physics compliant machine learning in accordance with aspects of the present disclosure;

FIG. 2 is a block diagram of an exemplary process for configuring a machine learning model in accordance with aspects of the present disclosure;

FIG. 3 is a block diagram of an extension of a machine learning model configuration process in accordance with aspects of the present disclosure;

FIGS. 4A-4F show block diagrams illustrating exemplary aspects of processes for configuring a PCI-based modelling process in accordance with aspects of the present disclosure;

FIGS. 5A and 5B show block diagrams illustrating exemplary aspects for configuring performance criteria for a Physics Compliance Indicator (PCI)-based modelling process in accordance with the present disclosure;

FIG. 6 is a block diagram illustrating a process for configuring criteria for a training process in accordance with aspects of the present disclosure;

FIGS. 7A-7G show various diagrams illustrating exemplary physical responses for verifying PCI compliance in accordance with aspects of the present disclosure;

FIGS. 8A-8D show diagrams illustrating exemplary outputs indicating compliance of a machine learning model with physics-based constraints in accordance with aspects of the present disclosure; and FIG. 9 is a flow diagram of an exemplary method for performing PCI-based modelling in accordance with aspects of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

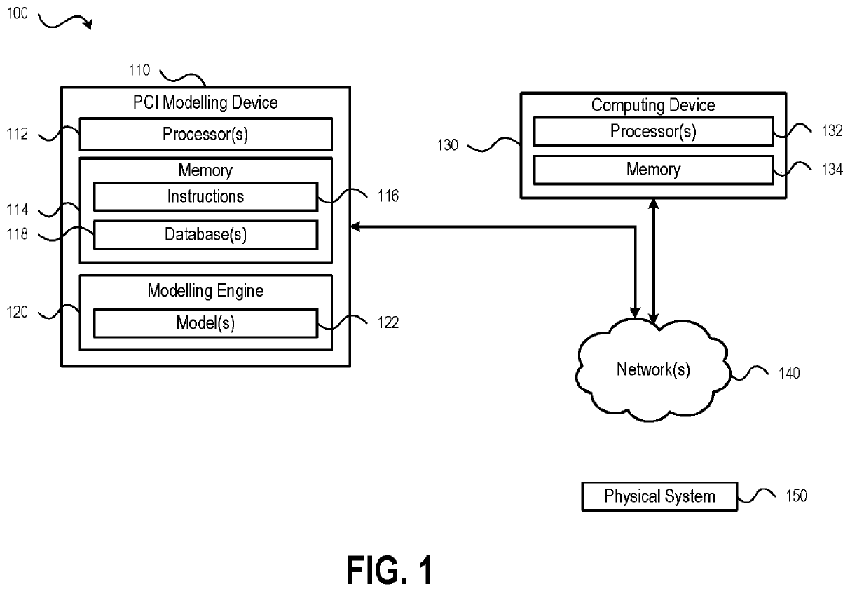

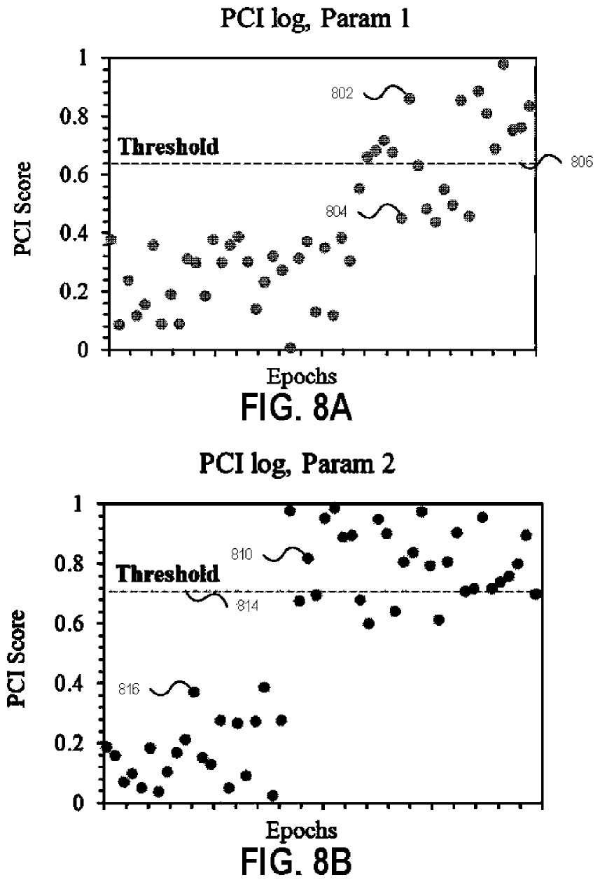

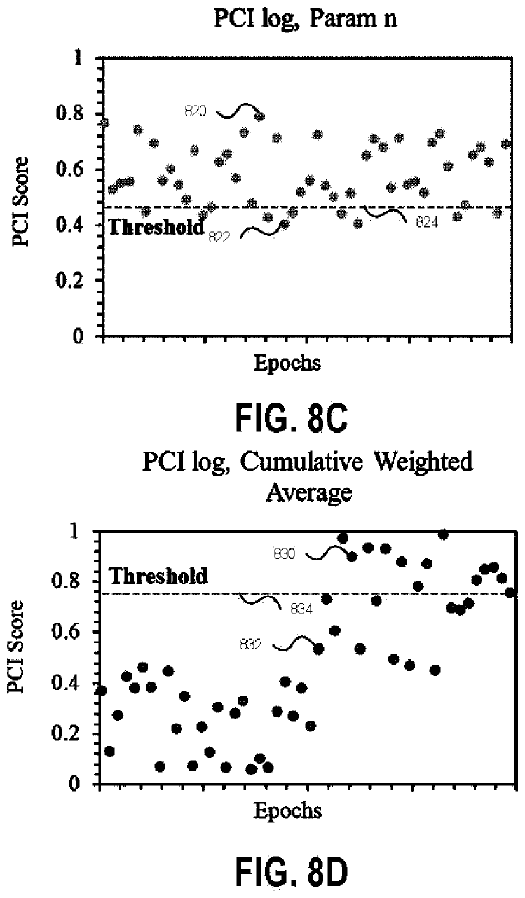

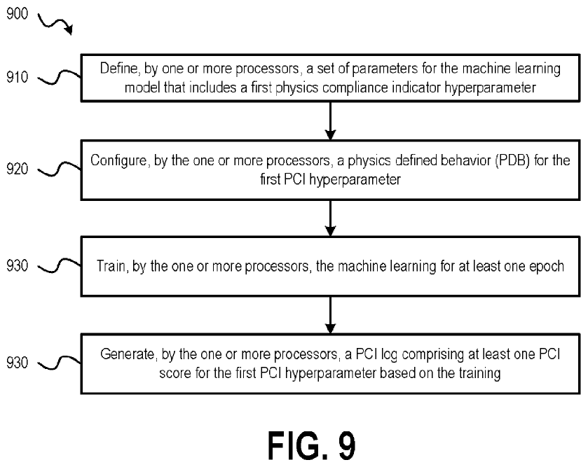

Referring to FIG. 1, a block diagram of an exemplary system for performing physics compliant machine learning in accordance with aspects of the present disclosure is shown as a system 100. As shown in FIG. 1, the system 100 includes a physics compliance indicator (PCI) modelling device 110. As described in detail below, a Physics Compliance Indicator (PCI) modelling device 110 in accordance with aspects of the present disclosure provides mechanisms for performing machine learning modelling processes that achieve certainty with respect to compliance with physical laws applicable to the modelled system (e.g., a system subject to or impacted by the laws of physics). For example, the PCI modelling device 110 may account for the physics behaviors associated with a modelled system (e.g., models representing data or other types of information associated with physical systems, objects, devices, or other physical entities subject to the laws of physics) and generate outputs, referred to as PCI logs, that indicate the ability of the machine learning model to learn the impact of physical laws on the modeled system, shown in FIG. 1 as system 150. The system 150 may be any type of real-world system impacted by the laws of physics, such as production of oil and/or gas from a well, autonomous vehicle operations, drug discovery processes, or other real-world systems and use cases. It is noted that the PCI logs may include parameter specific PCI logs indicating whether the model is able to learn and understand physical laws applicable to individual parameters (e.g., PCI parameter logs), as well as PCI logs associated with the overall compliance with all physical laws applicable to all parameters of the model impacted by physical laws (e.g., a cumulative PCI log). Exemplary aspects of PCI logs generated in accordance with the present disclosure are described in more detail below with reference to FIGS. 8A-8D.

The PCI modelling device 110 includes one or more processors 112, a memory 114, and a modelling engine 120. The one or more processors 112 may include one or more microcontrollers, application specific integrated circuits (ASICs), field programmable gate arrays (FPGAs), central processing units (CPUs) and/or graphics processing units (GPUs) having one or more processing cores, or other circuitry and logic configured to facilitate the operations of the PCI modelling device 110 in accordance with aspects of the present disclosure. The memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. As shown in FIG. 1, the memory 114 may also store instructions 116 that, when executed by the one or more processors 112 (or other processing logic), cause the one or more processors 112 to perform the operations described herein with reference to the PCI modelling device 110. Additionally, the memory 114 may store information in one or more databases 118. The databases 118 may include data that may be used to train and/or configure a machine learning, such as an ANN, in a manner that validates compliance with physical laws in a verifiable way, as described in more detail below.

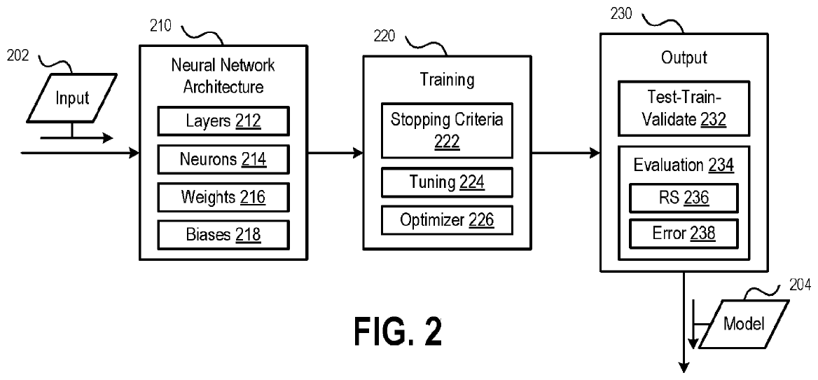

The PCI modelling device 110 includes a modelling engine 120 providing functionality to design, configure, test, validate, and generate machine learning models 122. To illustrate the functionality provided by the modelling engine 120 and referring to FIG. 2, a block diagram of an exemplary process for configuring a machine learning model in accordance with aspects of the present disclosure is shown. As briefly described above, training of a machine learning model, such as an artificial neural network (ANN), may be performed over many cycles or timesteps, referred to as epochs. One challenge that remains unsolved is the ability to train a model in a manner that provides confirmation that the model complies with physical laws applicable to the use case being modeled, resulting in uncertainty with respect to the modeled system or behaviors. As will be described in detail below, a training process configured in accordance with the present disclosure may eliminate this uncertainty by providing mechanisms for evaluating physics compliance of a machine learning model, such as an ANN, thereby providing a PCI compliant model in which the impact of physical laws is understood and accounted for by the model.

As shown in FIG. 2, a process for configuring a machine learning model may involve designing the model, at block 210; training the model, at block 220; and generating the final model, at block 230. In the specific example shown in FIG. 2, exemplary operations for configuring an ANN are shown, however, other types of models may involve similar processes but with some variation to address model differences. At block 210, which illustrates exemplary operations for configuring an ANN architecture, may include a set of layers 212, a set of neurons 214, weights 216, and biases 218. The layers 212 may include an input layer, an output layer, and one or more hidden layers. The input layer may be configured to accept values from a set of input data 202. The hidden layers may be configured to identify patterns or features from the input data. The output layer may be configured to output information associated with the identified patterns or features. The layers 212 may be composed of neurons 214 that may be activated by activation functions, which are functions designed to turn on specific neurons for processing the input data, either through the input layer, the hidden layers, or the output layer. The weights 216 may be configured to organize the variables by importance and impact of contribution. The biases 218 may be configured to shift the value given by the activation function. It is noted that exemplary components of the ANN architecture described above have been provided for purposes of illustration, rather than by way of limitation and the other features and components may be configured at block 210 for other machine learning models as well as ANNs.

Once the model architecture is configured, the model may be trained. To facilitate training, at block 220, stopping criteria 222 may be configured. The stopping criteria 222 may specify criteria for stopping training of the model (e.g., an ANN). For example, the stopping criteria may specify a number of epochs (or cycles) for performing training. During training of the model, hyperparameters of the model may be tuned, at block 224, to optimize the model's ability to learn and improve model performance. In addition to tuning hyperparameters, other parameters (e.g., model parameters) may be optimized, at block 226.

As indicated at block 230, a test-train-validate process 232 may be used to train the model, test the model, and validate the model's performance. To determine whether the model provides an acceptable level of performance, the model performance may be evaluated, at block 234. Evaluation of the model may be based on regression analysis, such as R-squared (R²) values 236 and/or error values 238 (e.g., mean square error (MSE), mean absolute error (MAE), etc.). Once the model is tested, trained, and validated, a final model 204 may be output (e.g., as the model 122 of FIG. 1).

Referring back to FIG. 1, using the functionality provided by the process for configuring a machine learning model shown in FIG. 2 may enable the creation of a machine learning model (e.g., the model 122) configured to model a target system, device, object, or other real-world use case or situation that involves or is impacted by the laws of physics. As explained above, traditional techniques for designing, training, testing, and validating an ANN (or other types of machine learning models) may result in uncertainty about the model's ability to accurately handle analysis of data sets representing use cases impacted by physical laws. To overcome these drawbacks, the modelling engine 120 may also provide functionality for extending the machine learning model design process shown in FIG. 2 to provide functionality for quantifying, and therefore providing certainty or some level of assurance, whether the model 122 learns the impact of physical laws on the modeled system.

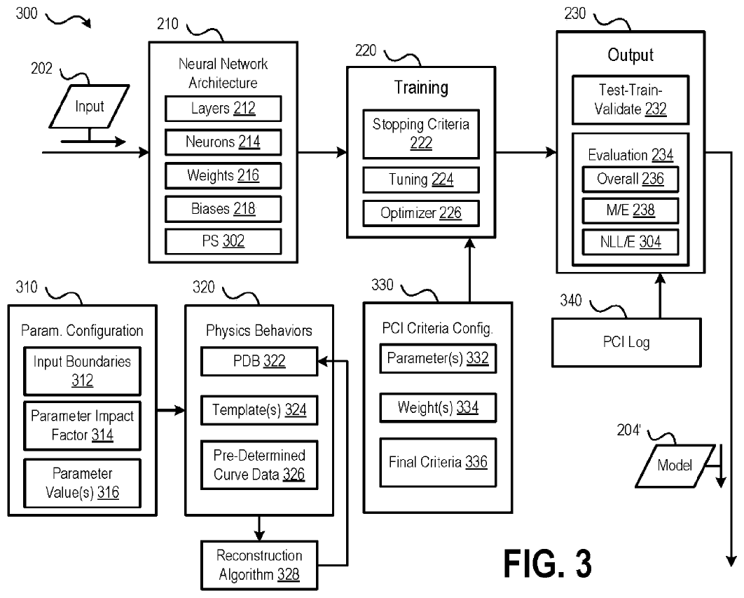

For example, and referring to FIG. 3, a block diagram 300 of an extension of a machine learning model configuration process in accordance with aspects of the present disclosure is shown. As shown in FIG. 3, at block 310, a parameter initialization process may be performed in which hyperparameter and other parameters of the model are configured. For example, at 312, input boundaries may be defined. At 314, parameter impact factors may be set, and p-values may be configured at block 316. Exemplary aspects of configuring the input boundaries, hyperparameters, impact factors, and p-values are described in more detail below.

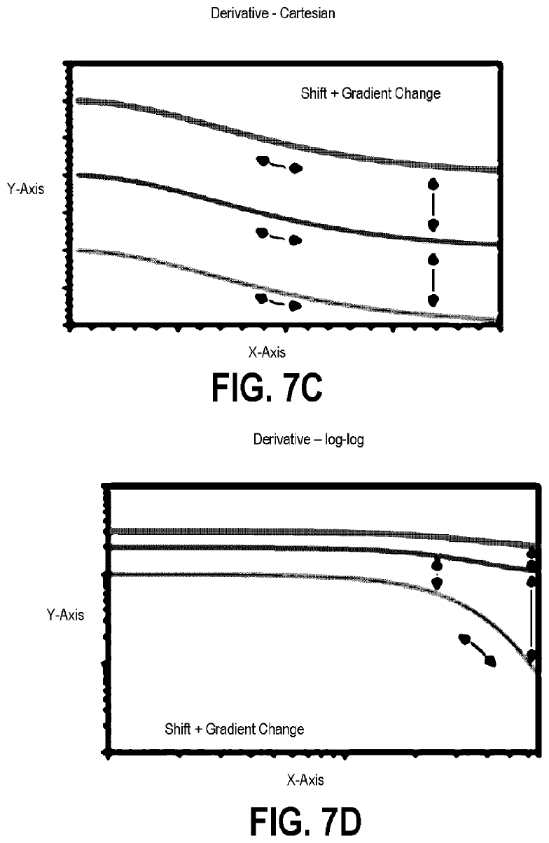

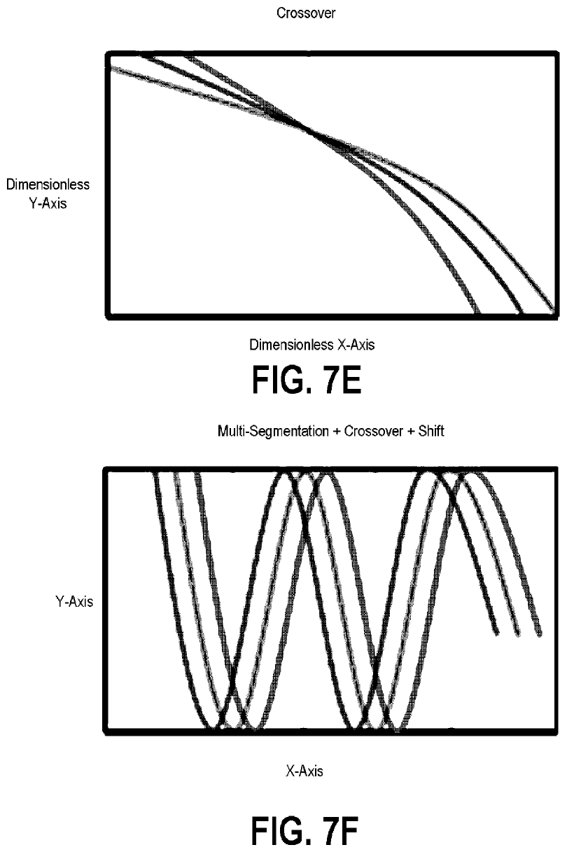

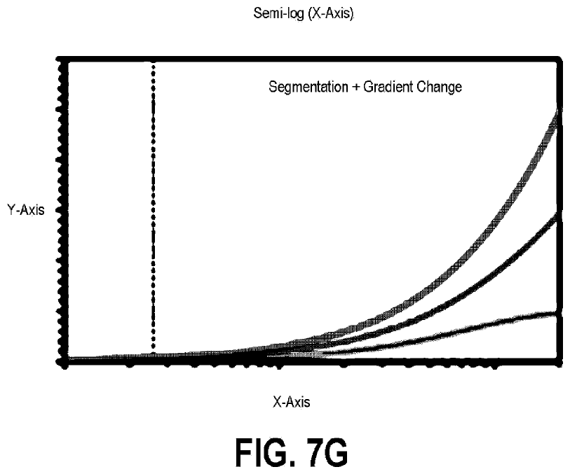

At block 320, the model may be configured with information associated with physics behavior information. For example, at block 322 physics based behaviors (PDB) may be defined. The PDBs may be defined using PDB templates 324 or using pre-determined curve data 326, such as PDB data defined by a user or image data. Non-limiting examples of PDB data that may be used to configure a modelling process in accordance with aspects of the present disclosure are described in more detail below with reference to FIGS. 7A-7G. Once the PCI parameters are configured, at block 310, and the PDBs are defined, at block 320, a reconstruction algorithm 328 may be used to process the original data format of the behavior input, digitize the meaningful patterns, transform the patterns to data points and eventually recognize the expected behavior from the intended physics embedded in the behavior input. In an aspect, the reconstruction algorithm may be implemented using a graph/image digitizer and the behavior input data may be in the form of digital point data or image data. However, it is noted that other techniques may be utilized in accordance with the concepts described herein to provide the functionality described herein with respect to the reconstruction algorithm if desired. In an aspect, the operations described with reference to block 320 and the reconstruction algorithm 328 may be performed multiple times to refine the model.

At block 330, various PCI criteria may be configured. For example, parameters 332, weights 334, and final criteria 336 may be configured. The parameters 332 may include one or more thresholds, such as thresholds indicating whether the model provides for sufficiently learning physics defined behaviors, such as those defined by the PDBs 322. In an aspect, the parameters 332 may be associated with specific parameters, such as parameters associated with each individual physics defined behavior. In an aspect, the weights 334 may be configured to account for weightings of each individual parameter and may specify one or more thresholds associated with the model as a whole, rather than thresholds associated with individual parameters as in the parameters 332. The final criteria 336 may represent a stopping criteria for training the model. As a non-limiting example, the final criteria 336 may define a threshold number of epochs. As another example, the final criteria 336 may define a threshold number of epochs in which the parameters satisfy the threshold defined by the parameters 332 and/or 334. It is noted that other final stopping criteria may also be defined according to the particular model and/or use case under consideration.

As shown in FIG. 3, the PCI criteria generated at block 330 may be applied during training of the model, at block 220. Using the PCI-enabled training process may result in a PCI informed model 204′. Additionally, as a result of the operations performed at block 230, one or more PCI logs 340 may be generated. Exemplary aspects of different types of PCI logs that may be generated are described below with reference to FIGS. 8A-8D.

It is noted that the exemplary process for configuring and extending a machine learning model using PCI techniques according to the present disclosure may be applied to both deterministic and probabilistic machine learning models. Where aspects of the present disclosure are applied to such deterministic and/or probabilistic machine learning models, various additional configuration options may be configured. To illustrate, weights and biases (e.g., the weights 216 and the biases 218 of FIG. 2) may be initialized as fixed values for deterministic machine learning algorithms and models. A set of optimal fixed values for the weights and biases may be determined once training is complete, which may be different from the initial fixed values used during training. In contrast, weights and biases for probabilistic machine learning algorithms and models may be unitized as priors (i.e., empirical statistical distributions). A deterministic machine learning algorithm or model generated using the above-describe configuration options may be configured to predict a point estimate (e.g., because the weights and biases are set to fixed values).

Additionally, probabilistic settings 302 may be configured for probabilistic machine learning algorithms and models (e.g., Bayes Neural Networks (BNNs)), which are transferred to and impact operations associated with tuning and optimization (e.g., blocks 224 and 226 of FIG. 2, respectively). As a non-limiting example, a posterior estimator and a variational estimator may be used to tune the initial probabilistic settings to produce or obtain optimal probabilistic settings based on the priors and a set of inputs (e.g., the inputs 202 of FIGS. 2 and 3). The optimal probabilistic settings for the weights and biases obtained during tuning, referred to as posteriors, may be used to replace the initial weights and biases priors prior to performing validation, testing, and eventually generating the final model (e.g., the model 204′of FIG. 3). The probabilistic settings may also impact the machine learning algorithm or model with respect to prediction quantification (e.g., the prediction and quantification capabilities of the model 204′of FIG. 3). To illustrate, the optimized posteriors, combined with a Negative Log Likelihood (NLL) option 304, may be used to impart epistemic properties to a probabilistic machine learning algorithm or model. As a result of the various configuration options associated with machine learning algorithms or models, as described above, the machine learning algorithms or models may be configured to predict a statistical distribution, rather than a point estimate as would be produced using the above-described modifications for deterministic machine learning algorithms or models. The prediction of a statistical distribution using a probabilistic machine learning algorithm or model may provide extra adaptation and flexibility to any shift in the inputs. It is noted that using the above-describe techniques to train, test, validate, and generate a machine learning algorithm or model may enable rapid development of deterministic and probabilistic models, while also preventing deterministic models from being impacted by the probabilistic setting and vice versa, thereby providing a robust mechanism for designing both deterministic and probabilistic machine learning algorithms or models in an efficient manner. Additionally, it is noted that deterministic and probabilistic machine learning models generated in accordance with the concepts disclosed herein (e.g., machine learning algorithms or models compliant with applicable physics principles) may facilitate additional techniques to analyze data sets (e.g., the inputs 202 of FIGS. 2 and 3).

As can be appreciated from the foregoing, aspects of the present disclosure provide a new process for designing, configuring, training, and testing machine learning models, such as ANNs and BNNs, in a manner that enables compliance of the model with physical laws to be accounted for with certainty (e.g., quantified, verified, etc.), thereby overcoming the limitations of current model configuration processes which can model physics-impacted use cases but do not provide a mechanism for validating compliance with physical laws. Such abilities may be particularly useful for many use cases for which machine learning is of interest, such as autonomous vehicles, oil and gas exploration and production, drug discovery, surgical applications, and the like. It is noted that these exemplary use cases are provided by way of non-limiting example, rather than by way of limitation, and that the concepts described herein may be readily applied to machine learning models associated with other use cases in which physical laws may impact the outputs of the model(s).

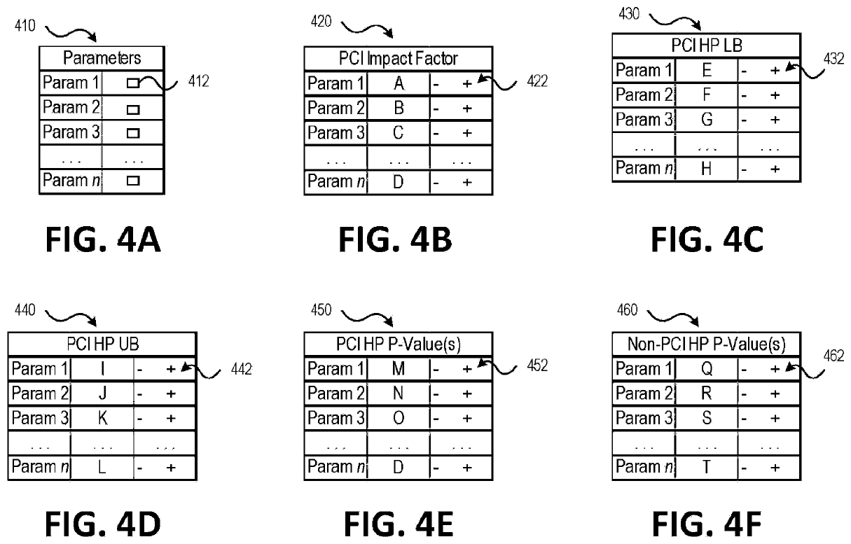

Referring back to FIG. 1, the modelling engine 120 may be configured to provide functionality supporting the various extensions and operations described above with reference to FIG. 3, which support processes to generate machine learning models (e.g., ANNs) capable of quantifying the impact of physics defined behaviors on parameters of a machine learning model and the ability of the model(s) to learn those physic defined behaviors. In an aspect, all or a portion of the configuration functionality described above with reference to FIG. 3 may be provided via one or more graphical user interfaces provided by the modelling engine 120. Exemplary aspects of the various interfaces are described below with reference to FIGS. 4A-8D.

Referring to FIGS. 4A-4F, block diagrams illustrating exemplary aspects of processes for configuring a PCI-based modelling process in accordance with aspects of the present disclosure are shown. In FIG. 4A a diagram 410 illustrating a process for selection of parameters for a machine learning model is shown. In an aspect, a set of available parameters for a model may be available and a user may select one or more of the available parameters for the model being designed. For example, a user interface may provide checkboxes 412 that enable a user to select one or more parameters from among a list of the available parameters. It is noted that other techniques may be used to designate a selected set of parameters for a particular machine learning model. In aspect, the parameter selected using the process shown in the diagram of FIG. 4A may correspond to PCI hyperparameters, representing PCI parameters identified from a set of input parameters to be used for physics compliance checks during model development using any neural networks and other artificial intelligence and machine learning algorithms. In an aspect, the PCI hyperparameters may be used for regression and classification.

Once the set of parameters is selected, PCI impact factors may be configured for each parameter. An exemplary process for configuring the PCI impact factors is shown in diagram 420 of FIG. 4B. As shown in FIG. 4B, the set of parameters may include n, where n>0, and each parameter may be assigned an impact factor, shown in diagram 420 as A, B, C, . . . , D. In an aspect, the impact factors may include numerical values that may be assigned or configured using a graphical user interface. For example, the graphical user interface may provide interactive elements 422 (e.g., buttons, icons, symbols, etc.) to enable a user to increase decrease the impact factor associated with each parameter to a desired value. In an aspect, the impact factor may represent an impact that each parameter has on the overall and final PCI (e.g., the cumulative impact of each PCI parameter represents the overall impact that physics has on the modeled system). For example, the impact factors may be represented as numerical values or weights between 0 and 1 and a sum of the numerical impact factor values may equal 1. In such an example, each parameter impact value represents an impact or weight of the corresponding parameter on the PCI compliance of the model such that the sum of the impact of all parameters represents 100% of the impact. In an aspect, the configuration of PCI impact factors 314 may be performed as described above.

In addition to parameter selection and assignment of PCI impact factors, as described above, configuration of a model may also include configuring upper and lower boundary settings of the parameters for the model. For example, FIG. 4C shows a diagram 430 illustrating an exemplary process for configuring PCI hyperparameter lower boundary settings, and FIG. 4D shows a diagram 440 illustrating an exemplary process for configuring PCI hyperparameter upper boundary settings. In an aspect, the upper and lower hyperparameter boundary settings may be configured based on training of the model. For example, training data may be used to configure the upper boundary settings for each parameter based on the highest value contained for each parameter and the lower boundary settings for each parameter based on the lowest value contained for each parameter. In an additional or alternative aspect, the upper and lower boundary settings for each parameter may be configured individually using interactive elements 432, 442 (e.g., buttons, icons, symbols, etc.). The upper and lower boundary settings for the hyperparameters may ensure that hyperparameter values do not go out of acceptable ranges during user of the model (e.g., either during or after training). In an aspect, the lower and upper bounds may be configured based on variations of the PCI parameters values from a selected base case, which may be selected by a user or by the modelling engine 120 of FIG. 1 automatically. In such instances, individual PCI hyperparameter values may be varied while keeping other non-PCI parameters values unchanged. The lower and upper range boundaries may provide a mechanism for checking that the selected values do not go out of range of the whole training and testing dataset.

In addition to configuring hyperparameter upper and lower boundary settings, other model parameter settings may also be configured in accordance with the present disclosure. For example, FIG. 4E shows a diagram 450 illustrating a process for configuring PCI hyperparameter P-values and FIG. 4F shows a diagram 460 illustrating a process for configuring non-PCI hyperparameter P-values. In an aspect, the configuration of the PCI hyperparameter P-values and non-PCI hyperparameter P-values may correspond to configuration of the parameter values 316 described above with reference to FIG. 3. In an aspect, the parameter values may be configured individually using interactive elements 452, 462 (e.g., buttons, icons, symbols, etc.). In an aspect, the P-values may be configured using a cumulative probability distribution (e.g., P1 to P100) calculated using a train and test dataset. As described above with reference to FIGS. 2 and 3, configuration of the various model parameters shown in FIGS. 4A-4F may enable a machine learning model, such as an ANN, to be configured in a manner that supports PCI-based modelling in accordance with the present disclosure.

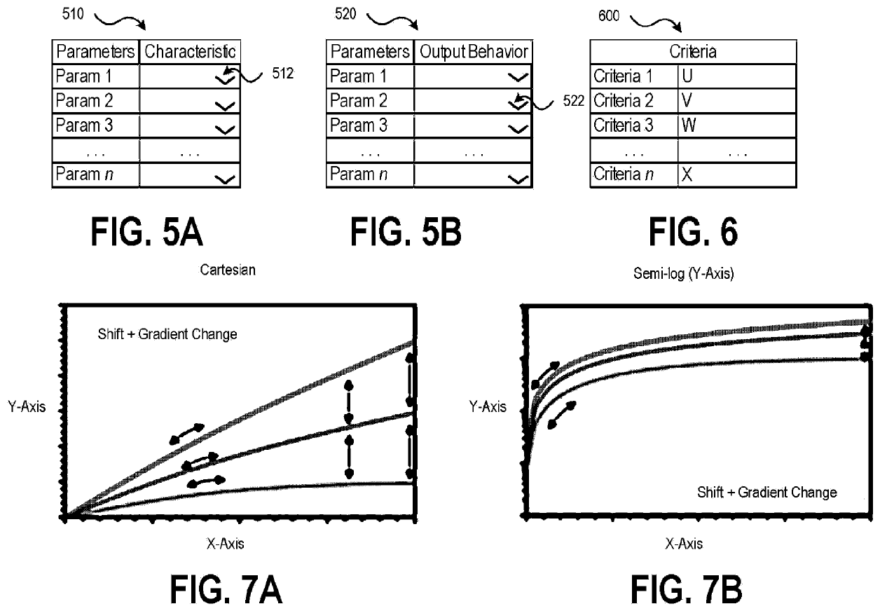

Referring to FIGS. 5A and 5B, block diagrams illustrating exemplary aspects for configuring performance criteria for a PCI-based modelling process in accordance with the present disclosure are shown. In an aspect, the configuration operations shown in FIGS. 5A and 5B may correspond to the configuration process described above with reference to FIG. 3 and more specifically, configuration of PDBs for a machine learning model at block 320 of FIG. 3. In FIG. 5A, a diagram 510 shows a process for configuration of characteristics of PDBs associated with each parameter. In an aspect, the configuration of the PDB characteristic(s) for each parameter may be configured using interactive elements of a graphical user interface, such as drop down menus 512 displaying a list of PDBs. As an example, the characteristics of the PDBs that may be configured may specify shift characteristics (e.g., constant upward or downward shifts), gradient characteristics (e.g., gradients upward or downward), curves or curvatures, crossovers or twists, multi-segmentations, or other PDB characteristics. As described above with reference to FIG. 3, configuration of the PDB characteristics may defined using templates, images, or other types of data.

In FIG. 5B, a diagram 520 illustrating exemplary aspects of configuration output behavior of the PDBs is shown. In an aspect, the configuration of the PDB output behavior(s) for each parameter may be configured using interactive elements of a graphical user interface, such as drop down menus 522 displaying a list of output behaviors. The output behaviors for the PDBs may specify a type of plot or graph that may be used to represent the PDB. Exemplary and non-limiting output behaviors may include Cartesian behaviors, spherical behaviors, dimensionless behaviors, derivative behaviors, user-defined behaviors, and the like. As described above with reference to FIG. 3, configuration of the PDB output behaviors may be defined using templates, images, or other types of data. In some aspects, the PDB characteristics and behaviors may be defined using a same template or image. Exemplary PDB characteristics and output behaviors are described in more detail below with reference to FIGS. 7A-7G.

Referring to FIG. 6, a block diagram illustrating a process for configuring criteria for a training process in accordance with aspects of the present disclosure is shown as a diagram 600. In an aspect, various criteria may be defined, shown in FIG. 6 as criteria values U, V, W, . . . , and X. Value U may be a criteria associated with whether training of a model should utilize the PCI parameter configuration shown in FIG. 3. Value V may indicate a number of epochs to perform before stopping training for evaluation, testing, and validation, values W may indicate parameter PCI thresholds, described in more detail below with reference to FIGS. 8A-8C, and value X may indicate an overall threshold, as described in more detail below with reference to FIG. 8D. The exemplary criteria configuration process shown in FIG. 6 may be used to monitor training of a machine learning model and evaluate whether training of the model in a PCI compliant manner is successful (i.e., the model can be validated with respect to compliance with physical laws and constraints), thereby eliminating the uncertainty associated with current machine learning processes for which compliance with physical laws remains uncertain. Using the criteria described above, a user may activate or deactivate PCI-based stopping criteria by toggling the value U, however, it is noted that performing training with PCI-based stopping turned off may cause significant loss, model instability, and failure in prediction since it may not comply with the physics. When turned on, PCI stopping criteria are used (e.g., U set to true), the training process may be monitored according to the number of last epochs that satisfy all thresholds of each PCI input parameter's score and the PCI cumulative score (e.g., based on the values configured to V (epochs), W (PCI parameter score thresholds), and X (cumulative PCI score). The PCI stopping criteria provide an intelligent way to monitor the progress of the training and provide opportunities for tuning as the model learns the physics of the modeled system.

Referring to FIGS. 7A-7G, diagrams illustrating exemplary physical responses for verifying PCI compliance in accordance with aspects of the present disclosure are shown. As explained above, a machine learning model, such as an ANN, may be used to model and understand various types of systems, data, or other types of information and use cases. Many such machine learning models may involve data associated with real-world systems, objects, devices, or other physical entities that may be subject to the laws of physics. For such models to provide sufficient understanding of the behavior of the modelled subject matter, the model must be capable of learning which model parameters impact the physical response that should be observed for a given set of data representing the modelled subject matter. To illustrate, in a model of the behavior of an oil and gas well, production of oil and/or gas from the well may impact the behavior of the well over time. To sufficiently understand the behavior of the well using a machine learning model, the model must be trained to learn which parameters of the model impact physical responses. To facilitate such learning, a machine learning model in accordance with the present disclosure may be configured with expected physical response behaviors for the parameters of the model.

In the diagram of FIG. 7A a physical response involving a shift and gradient change is shown, where the x-axis represents a change in the value of one or more parameters and the y-axis represents the output or response. It is noted that in the example of FIG. 7A the plots are generated using Cartesian coordinates. In the exemplary response of FIG. 7A the response is expected to exhibit a shift in value (e.g., increasing or decreasing) as the parameter value(s) increases. Also, as can be observed in FIG. 7A, the shift exhibits a gradient change (e.g., a change in the rate or slope at which the value increases or decreases). The gradient change indicates that as the value(s) of the parameter(s) increases the rate of change in the physical response also changes. Such a shift and gradient change response may indicate that impact that changes in parameter values have on the sensitivity of the model, and more specifically, the parameters represented by the physical system response plot. So, for example, the bottom plot of FIG. 7A illustrates a response in which the shift and gradient change flattens out more quickly as compared to the other two plots.

It is noted that plotting physical response behaviors using Cartesian coordinates may not be suitable for all physical responses and/or parameters. Thus, it should be understood that other techniques may be used to generate plots representing physical response behaviors in accordance with the concepts disclosed herein. For example, in FIG. 7B a plot of a physical response involving a shift and gradient change generated using semi-log techniques is shown. It is noted that the physical response (e.g., a shift and gradient change) shown in the plot of FIG. 7B is the same type of physical response shown in the plot of FIG. 7A, but the physical response plotted in FIG. 7B may not be readily observed were it to be plotted using Cartesian coordinates, as in FIG. 7A, due to differences in the type of physical response, the parameter(s) associated with the physical response, or other factors. Thus, it is to be appreciated that evaluating a model's ability to learn physical responses may take into account a variety of different types of physical responses, the types of impact that various parameters of the model have on the physical responses, or other factors. Additional exemplary physical response impact models are shown in FIGS. 7C-7G, described in more detail below.

It is noted that FIGS. 7A-7G, described above have been described for purposes of illustration, rather than by way of limitation and are intended to provide non-limiting examples of different types of physical response behaviors that may be learned by an artificial intelligence model or algorithm in accordance with aspects of the present disclosure and the PCI-based techniques disclosed herein. In practice, the physical response behavior plots may be defined by a user (e.g., using PCI-based suggestions or processed inputs from the user). It is noted that such user-defined behaviors may be examined with respect to PCI performance and may be refined or changed over time, It is also noted that the exemplary plotting techniques described above have been provided for purposes of illustration, rather than by way of limitation and that other plotting techniques may be utilized in accordance with the concepts described herein. For example, the PCI techniques disclosed herein are highly adaptable and may be utilized across a variety of domains and industries. As such, it should be understood that advantageous plotting forms and techniques may be determined and used to inform the PCI-based techniques of the present disclosure according to a user's domain expertise and the physical system(s) involved. As a non-limiting example, a model may have parameters 1-n, where parameters 1, 5, and n-4 have an impact on the final modeled response of the physical system. The response may look different depending how it is plotted (e.g., different plot techniques may more readily show responses for different types of responses, physical systems, data, or other factors). Thus, the response may not be visually understood or apparent when plotted with a first technique but may be easily visualized and understood if plotted using another technique.

To further illustrate how different plotting techniques and physical responses may be used in accordance with the present disclosure, FIGS. 7C-7G illustrate additional responses and plotting techniques. For example, FIG. 7C shows a shift and gradient change response plotted using a derivative Cartesian technique; FIG. 7D shows a shift and gradient change response plotted using a derivative-log-log technique; FIG. 7E shows a physical response showing a crossover, FIG. 7F shows a physical response showing a multi-segmentation with crossover and shift; and FIG. 7G shows a segmentation and gradient change physical response plotted using semi-log (x-axis). It is noted that the exemplary PDBs and response behaviors shown in FIGS. 7A-7G have been provided for purposes of illustration, rather than by way of limitation and that other PDB response behaviors may be accounted for by PCI modelling devices in accordance with the present disclosure.

In an aspect, the PDBs (e.g., the PDBs of FIGS. 7A-7G) may be selected by a user (e.g., modeler(s) or developer(s)), as described above with reference to FIGS. 5A and 5B. In an additional or alternative aspect, the PDBs (e.g., the PDBs of FIGS. 7A-7G) may be selected automatically (e.g., by the modelling engine 120 of FIG. 1 or another autonomous system or robot). Regardless of whether the PDBs are selected by a user or autonomously, the configured or selected PDBs should reflect the expected model's or system's response and behavior changes with respect to variation of selected PCI input parameters (e.g., the parameters descried above with reference to FIG. 4A). The variation of the PCI input parameters may exhibit different responses to the relevant physics, as described above. These differences may be captured based on behavior inputs provided by the user and/or may be learned automatically (e.g., based on data or images representing the response behavior). In an aspect, when the response behavior for the PDBs is selected automatically, information regarding the PDB(s) may be presented to a user for confirmation/acceptance. In such a scenario, the expected behavior may be extracted from the image(s) or data and incorporated into the model as described above.

In an aspect, the modelling engine may be configured to automatically determine the PDBs for each parameter and then the user may be provided with the ability to override the automatically selected PDBs. In such instances, the PDB behaviors input by the user may override the automatically determined PDB behaviors, and the reconstruction algorithm may be activated to update the model based on the PDB behaviors specified by the user. As described above, the reconstruction algorithm processes the original data format of the behavior input, digitizes the meaningful patterns, transforms them to data points and eventually recognizes the expected behavior from the intended physics embedded in the behavior input, where the expected behavior represents the understanding of the underlying physics of the modeled system

Referring to FIGS. 8A-8D, diagrams illustrating outputs indicating PCI compliance of a machine learning model in accordance with aspects of the present disclosure are shown. As explained above, training of a machine learning model, such as an ANN, may be performed over many cycles, referred to as epochs. The expected behavior, representing the ability of the model to understand the underlying physics of the system, may be determined (e.g., during each epoch) and an output may be generated to represent the determined understanding of the model. In an aspect, a score may be generated for each PCI input parameter (e.g., each parameter impacting the physical response), which may be referred to as PCI parameter scores. As a non-limiting example, the PCI parameter scores may be assigned values between 0 and 1 at each epoch of the model training and testing process, and the PCI parameter scores may represent an accuracy measurement of the prediction sensitivity at each epoch (i.e., how well the model understands or learns the physical laws of the modeled system). In addition to PCI parameter scores, an overall or cumulative PCI score (herein after “cumulative PCI score”) may also be generated, which may represent the model's overall ability to understand the physical laws of the modeled system as a whole. In an aspect, the cumulative PCI score may also be represented as a value between 0 and 1. It is noted that while described as being scored having values between 0 and 1 above, it is to be appreciated that the PCI parameter scores and cumulative PCI score may be assigned other values if desired, such as values between 1 and 10, 1 and 100, letter values (e.g., A-F), and the like depending on the particular design of the system, the level of granularity to be provided by the scores, or other factors. Additionally, it should be appreciated that the scores may be generated using weighted scoring techniques. For example, the cumulative PCI score may be weighted based on a degree of importance of the respective PCI input parameters, such as applying greater weight to PCI input parameters that have a greater impact on the physical response and less weight to PCI input parameters that have a lesser impact on the physical response.

The scores (e.g., the PCI parameter scores and the cumulative PCI scores) may be maintained in one or more PCI logs, such as the PCI logs shown in FIGS. 8A-8D, which show diagrams illustrating exemplary outputs indicating compliance of a machine learning model with physics-based constraints in accordance with aspects of the present disclosure. FIGS. 8A-8C represent PCI logs for PCI parameter scores of three different PCI input parameters and FIG. 8D shows an exemplary PCI log for a cumulative PCI score associated with the PCI input parameters represented in the PCI logs of FIGS. 8A-8C. As can be seen in FIGS. 8A-8D, each PCI log includes a threshold (e.g., thresholds 806, 814, 824, 834) and PCI scores, shown as dots. The dots in each PCI log represent the PCI scores of the respective scored parameters or cumulative scores and include some PCI scores above the thresholds (e.g., parameter values 802, 810, 820, 830) and some PCI scores below the thresholds (e.g., parameter values 804, 816, 822, 832). The thresholds shown in FIGS. 8A-8D may represent satisfactory levels of performance that may serve as an indication that training of a model is satisfactory with respect to the model's ability to understand certain ones of the physical laws applicable to the model (e.g., in the case of FIGS. 8A-8C) or the overall training of the model with respect to all relevant physical laws (e.g., in the case of the cumulative PCI scores represented in the PCI log of FIG. 8D). In the exemplary PCI logs shown in FIGS. 8A-8D, epochs are plotted along the x-axis and the PCI scores are plotted on the y-axis. The thresholds (806, 814, 824, 834) represent scoring thresholds indicating satisfactory model performance with respect to the relevant physical response during training of the model or overall model performance. The PCI logs provide a visual representation of the model's ability to understand or learn physics defined behaviors, thereby providing a mechanism for evaluating how well a model accounts for physical laws that impact the modeled system. In an aspect, the PCI scores, which are plotted on the y-axis of the plots of FIGS. 8A-8D, may be R² values. However, it should be understood that the PCI scores may be generated using other values if desired.

In an aspect, the PCI scores (e.g., PCI parameter scores and cumulative PCI scores) may be output to a graphical user interface after each epoch, thereby providing the user (e.g., a model designer) with a visual indication of the training progress and the model's ability to learn the impact of physics on the modeled system. Such visual indications may inform the modeler of whether the training is progressing and provide feedback that may be used to tune or optimize the parameters of the model to improve the ability of the model to learn the physics impact of each parameter. As a result, an enhanced model may be obtained that can account for the impact of physics on the modeled system with certainty (e.g., based on the individual and cumulative PCI scoring thresholds).

Referring back to FIG. 1, in an aspect, the functionality of the PCI modelling device 110 may be provided locally. For example, the instructions 116 may be stored as a program in the memory 114 and may be executed on a user's computing device to perform modelling processes consistent with the functionality described above. In an additional or alternative aspect, the functionality of the PCI modelling device 110 may be stored on a server accessible to a user associated with a computing device 130 over one or more networks 140. As shown in FIG. 1, the computing device 130 includes one or more processors 132 and a memory 134. The computing device 130 may include additional devices not shown in FIG. 1, such as input/output (I/O) devices, to enable a user to interact with the functionality provided by the PCI modelling device 110. In an additional or alternative aspect, the functionality provided by the PCI modelling device 110 may be deployed in a cloud-based system or other type of distributed system (e.g., a server farm) accessible to a user via the one or more networks 140.

Using the functionality provided by the PCI modelling device 110 and the modelling engine 120, as described above with reference to FIGS. 2-8D, enables machine learning models, such as ANNs, to be designed in a manner that provides for quantification and verification of the model's ability to learn physics defined behaviors, thereby overcoming the drawbacks of existing machine learning-based modelling techniques involving use cases impacted by physical laws. For example, training may be performed for one or more epochs and one or more PCI scores may be generated that indicate whether the model has learned the impact of physics defined behaviors for one or more parameters of the model and/or the model as a whole (e.g., for all parameters impacted by physics defined behaviors), as described above with reference to FIGS. 8A-8D. The PCI scores may provide information indicating the ability of the model to learn and account for the impact of physics defined behaviors, which enables training to be performed over a number of epochs until a threshold level of learning has been achieved (e.g., based on the PCI score thresholds described with reference to FIGS. 8A-8D). Moreover, the functionality provided by the modelling engine 120 enables physics defined behaviors to be associated with individual model parameters (e.g., as described with reference to FIGS. 4A-7G), thereby providing a fine level of granularity with respect to modelling of systems impacted by physical laws. Accordingly, it should be understood that the modelling engine 120 of FIG. 1 provides functionality providing improved capabilities to design, configure, tune, test, validate, and generate machine learning models for use cases impacted by physical laws and to do so in a manner that is capable of quantifying the model's ability to learn physics defined behaviors, thereby removing the uncertainty associated with existing machine learning model design and generation processes. It is noted that machine learning models configured in accordance with the system 100 and the concepts described above may be referred to as enhanced machine learning models, such as an enhanced-ANN (E-ANN). Such E-ANNs may represent an enhancement over prior ANNs due to the ability of the E-ANN to provide certainty with respect to the impact that physics has on the modeled system.

Referring to FIG. 9, a flow diagram of an exemplary method for performing PCI-based modelling in accordance with aspects of the present disclosure is shown as a method 900. In an aspect, the method 900 may be performed by a computing device, such as the PCI modelling device 110 of FIG. 1. In an aspect, operations or steps of the method 900 may be stored as instructions (e.g., the instructions 116 of FIG. 1) that, when executed by one or more processors (e.g., the one or more processors 112 of FIG. 1), cause the one or more processors to perform operations performing PCI-based modelling in accordance with aspects of the present disclosure, as described above with reference to FIGS. 1-8D.

At step 910, the method 900 includes defining, by one or more processors, a set of parameters for the machine learning model, the set of parameters including a first physics compliance indicator (PCI) hyperparameter. As described above with reference to FIGS. 1, 3, and 4A-4F, a machine learning model may include hyperparameters, including PCI hyperparameters associated with parameters of the model subject to or impacted by laws of physics. At step 920, the method 900 includes configuring, by the one or more processors, a PDB for the first PCI hyperparameter. As explained above with reference to FIGS. 4A-5B and 7A-7G, the PDB for the first PCI hyperparameter may indicate an expected response or behavior change with respect to variation of an input parameter, such as a shift, a gradient change, a shift and gradient change, a crossover, a multi-segmentation, other behaviors, or combinations thereof. In an aspect, configuring the PDB of the first PCI hyperparameter may include defining an output behavior, as described above with reference to FIG. 5B and FIGS. 7A-7G (e.g., Cartesian, semi-log, dimensionless, etc.).

At step 930, the method 900 includes training, by the one or more processors, the machine learning for at least one epoch; and at step 940, generating, by the one or more processors, a PCI log comprising at least one PCI score for the first PCI hyperparameter based on the training. As described above, each PCI score of the PCI log may quantify a compliance of the machine learning model with one or more physical laws during a particular epoch of the at least one epoch. The PCI scores of the PCI log may provide a measure that allows the performance of the model to be quantified with respect to the ability of the model to learn the impact of the physical laws on the modeled system. As explained above with reference to FIGS. 8A-8D, the PCI log(s) may include PCI logs based on PCI parameter scores (e.g., PCI scores for PCI hyperparameters) and cumulative a PCI log based on cumulative PCI scores (i.e., PCI scores quantifying the model's ability to learn and understand the impact of PDBs as a whole). As explained above, the PCI scores (e.g., PCI parameter scores and cumulative PCI scores) may be generated for each epoch of the training and training, at step 930, may continue until one or more stop criteria are satisfied, such as the stop criteria described above with reference to FIG. 6.

It is noted that while FIG. 9 has been described above as including the exemplary operations shown in FIG. 9 by steps 910-940, it should be understood that the method 900 may include additional steps and operations consistent with the description of the functionality of the PCI modelling device 110 and FIGS. 1-8D above. As shown above, the method 900 provides functionality that enables machine learning models, such as ANNs, to be designed in a manner that provides for quantification and verification of the model's ability to learn physics defined behaviors (e.g., based on the PCI log(s)), thereby overcoming the drawbacks of existing machine learning-based modelling techniques involving use cases impacted by physical laws. For example, training may be performed for one or more epochs and one or more PCI scores may be generated that indicate whether the model has learned the impact of physics defined behaviors for one or more parameters of the model and/or the model as a whole (e.g., for all parameters impacted by physics defined behaviors), as described above with reference to FIGS. 8A-8D. The PCI scores may provide information indicating the ability of the model to learn and account for the impact of physics defined behaviors, which enables training to be performed over a number of epochs until a threshold level of learning has been achieved (e.g., based on the PCI score thresholds described with reference to FIGS. 8A-8D), which may quantify the level of certainty with which the model accounts for the impact of the laws of physics on the modeled system. Moreover, operations of the method 900 enable physics defined behaviors to be associated with individual model parameters (e.g., as described with reference to FIGS. 4A-7G), thereby providing a fine level granularity with respect to modelling of systems impacted by physical laws, which enables even complex systems to be modeled with physical laws compliance certainty. Accordingly, it should be understood that the method 900 provides an improved process for designing, configuring, tuning, testing, validating, and generating machine learning models for use cases impacted by physical laws and does so in a manner that is capable of quantifying the model's ability to learn physics defined behaviors, thereby removing the uncertainty associated with existing machine learning model design and generation processes.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to various ones of FIGS. 1-9 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for quantifying an impact of physical laws on a machine learning model, the method comprising:
defining, by one or more processors, a set of parameters for the machine learning model, the set of parameters including a first physics compliance indicator (PCI) hyperparameter;
configuring, by the one or more processors, a physics defined behavior (PDB) for the first PCI hyperparameter, wherein the PDB for the first PCI hyperparameter indicates an expected response or behavior change with respect to variation of an input parameter;
training, by the one or more processors, the machine learning for at least one epoch; and
generating, by the one or more processors, a PCI log comprising at least one PCI score for the first PCI hyperparameter based on the training, wherein each PCI score of the PCI log quantifies a compliance of the machine learning model with one or more physical laws associated with the PDB of the first PCI hyperparameter during a particular epoch of the at least one epoch.

2. The method of claim 1, wherein the set of parameters includes one or more additional PCI hyperparameters, the method comprising:
configuring a PDB for each additional PCI hyperparameter of the one or more additional PCI hyperparameters; and
generating one or more additional PCI logs, each additional PCI log of the one or more PCI logs corresponding to a particular one of the one or more additional PCI hyperparameters and comprising at least one PCI score for the corresponding PCI hyperparameter based on the training.

3. The method of claim 1, further comprising outputting the PCI log to a graphical user interface.

4. The method of claim 1, further comprising generating a cumulative PCI log comprising cumulative PCI scores based on the training, wherein the cumulative PCI scores quantify the compliance of the machine learning model with all physical laws associated with a set of PDBs corresponding to the set of parameters during each epoch of the training.

5. The method of claim 1, further comprising:
configuring a set of PCI stopping criteria; and
determining, after each epoch of the training, whether to stop the training based on the set of PCI stopping criteria.

6. The method of claim 5, wherein the PCI stopping criteria comprises an epoch criterion, one or more PCI hyperparameter stopping criteria, and a cumulative stopping criteria, the epoch criterion specifying a threshold number of epochs, the one or more PCI hyperparameter stopping criteria comprising a PCI parameter stopping criteria associated with performance of the machine learning model with respect to PDBs associated with each PCI hyperparameter, and a cumulative stopping criteria associated with performance of the machine learning model with respect to all PDBs.

7. The method of claim 1, wherein the PDB of the first PCI hyperparameter is associated with response and behavior changes with respect to variation of the first PCI hyperparameter, and wherein the response and behavior changes are impacted by one or more physical laws.

8. The method of claim 1, wherein the machine learning model is an enhanced-artificial neural network.

9. A system for quantifying an impact of physical laws on a machine learning model, the system comprising:
a memory; and
one or more processors communicatively coupled to the memory, the one or more processors configured to:
define a set of parameters for the machine learning model, the set of parameters including a first physics compliance indicator (PCI) hyperparameter, wherein the machine learning model comprises an enhanced-artificial neural network;
configure a physics defined behavior (PDB) for the first PCI hyperparameter, wherein the PDB for the first PCI hyperparameter indicates an expected response or behavior change with respect to variation of an input parameter;
train the machine learning for at least one epoch; and
generate a PCI log comprising at least one PCI score for the first PCI hyperparameter based on the training, wherein each PCI score of the PCI log quantifies a compliance of the machine learning model with one or more physical laws associated with the PDB of the first PCI hyperparameter during a particular epoch of the at least one epoch.

10. The system of claim 9, wherein the set of parameters includes one or more additional PCI hyperparameters, the one or more processors configured to:
configure a PDB for each additional PCI hyperparameter of the one or more additional PCI hyperparameters; and
generate one or more additional PCI logs, each additional PCI log of the one or more PCI logs corresponding to a particular one of the one or more additional PCI hyperparameters and comprising at least one PCI score for the corresponding PCI hyperparameter based on the training.

11. The system of claim 9, wherein the one or more processors are configured to output the PCI log to a graphical user interface.

12. The system of claim 9, wherein the one or more processors are configured to generate a cumulative PCI log comprising cumulative PCI scores based on the training, wherein the cumulative PCI scores quantify the compliance of the machine learning model with all physical laws associated with a set of PDBs corresponding to the set of parameters during each epoch of the training.

13. The system of claim 9, wherein the one or more processors are configured to:
configure a set of PCI stopping criteria; and
determine, after each epoch of the training, whether to stop the training based on the set of PCI stopping criteria.

14. The system of claim 13, wherein the PCI stopping criteria comprises an epoch criterion, one or more PCI hyperparameter stopping criteria, and a cumulative stopping criteria, the epoch criterion specifying a threshold number of epochs, the one or more PCI hyperparameter stopping criteria comprising a PCI parameter stopping criteria associated with performance of the machine learning model with respect to PDBs associated with each PCI hyperparameter, and a cumulative stopping criteria associated with performance of the machine learning model with respect to all PDBs.

15. The system of claim 9, wherein the PDB of the first PCI hyperparameter is associated with response and behavior changes with respect to variation of the first PCI hyperparameter, and wherein the response and behavior changes are impacted by one or more physical laws.

16. A non-transitory computer-readable storage medium storing instructions that, when executed by one or more processors, cause the one or more processors to perform operations for quantifying an impact of physical laws on a machine learning model, the operations comprising:
defining a set of parameters for the machine learning model, the set of parameters including a first physics compliance indicator (PCI) hyperparameter, wherein the machine learning model is an enhanced-artificial neural network;
configuring a physics defined behavior (PDB) for the first PCI hyperparameter, wherein the PDB for the first PCI hyperparameter indicates an expected response or behavior change with respect to variation of an input parameter, wherein the PDB of the first PCI hyperparameter is associated with response and behavior changes with respect to variation of the first PCI hyperparameter, and wherein the response and behavior changes are impacted by one or more physical laws;
training the machine learning for at least one epoch; and
generating a PCI log comprising at least one PCI score for the first PCI hyperparameter based on the training, wherein each PCI score of the PCI log quantifies a compliance of the machine learning model with one or more physical laws associated with the PDB of the first PCI hyperparameter during a particular epoch of the at least one epoch.

17. The non-transitory computer-readable storage medium of claim 16, wherein the set of parameters includes one or more additional PCI hyperparameters, the operations comprising:
configuring a PDB for each additional PCI hyperparameter of the one or more additional PCI hyperparameters; and
generating one or more additional PCI logs, each additional PCI log of the one or more PCI logs corresponding to a particular one of the one or more additional PCI hyperparameters and comprising at least one PCI score for the corresponding PCI hyperparameter based on the training.

18. The non-transitory computer-readable storage medium of claim 16, the operations further comprising generating a cumulative PCI log comprising cumulative PCI scores based on the training, wherein the cumulative PCI scores quantify the compliance of the machine learning model with all physical laws associated with a set of PDBs corresponding to the set of parameters during each epoch of the training.

19. The non-transitory computer-readable storage medium of claim 16, the operations further comprising:
configuring a set of PCI stopping criteria; and
determining, after each epoch of the training, whether to stop the training based on the set of PCI stopping criteria.

20. The non-transitory computer-readable storage medium of claim 19, wherein the PCI stopping criteria comprises an epoch criterion, one or more PCI hyperparameter stopping criteria, and a cumulative stopping criteria, the epoch criterion specifying a threshold number of epochs, the one or more PCI hyperparameter stopping criteria comprising a PCI parameter stopping criteria associated with performance of the machine learning model with respect to PDBs associated with each PCI hyperparameter, and a cumulative stopping criteria associated with performance of the machine learning model with respect to all PDBs.
